(19) United States
(12) Patent Application Publication
(10) Pub. No.: US 2014/0021275 A1
(43) Pub. Date: Jan. 23, 2014

(54) Operating Method For A Jet Mill Plant And Jet Mill Plant

(71) Applicant: Roland Nied, Bonstetten (DE)

(72) Inventor: Roland Nied, Bonstetten (DE)

(21) Appl. No.: 14/032,892

(22) Filed: Sep. 20, 2013

Related U.S. Application Data
(63) Continuation of application No. PCT/DE2012/000194, filed on Feb. 25, 2012.

(30) Foreign Application Priority Data
Mar. 21, 2011 (DE) 10 2011 014 643.1

(51) Int. Cl. B02C 19/06

(52) U.S. Cl. CPC B02C 19/068
USPC 241/5; 241/39

(57) ABSTRACT

An operating method for a jet mill plant, wherein superheated steam at low pressure is used as an operating medium for a jet mill and the steam, after the jet mill and separation of grinding stock, is circulated back again into the jet mill via a compressor for excess pressure and temperature increase in the circuit. Furthermore, a jet mill plant includes a jet mill designed to operate with superheated steam at low pressure, wherein a jet mill steam discharge line, a compressor and a jet mill steam supply line form together with the jet mill a circuit for steam, so that steam is conveyed from the jet mill back again into the jet mill via the compressor for excess pressure and temperature increase in the circuit.

### FIELD OF THE INVENTION

The present invention relates to a jet mill plant and an operating method for a jet mill plant.

### BACKGROUND OF THE INVENTION

There are applications with jet mills for which the use of superheated steam, especially at a pressure of <10 bar(abs), is advantageous or necessary as an operating medium. For example, the use of high-energy steam as an operating medium is advantageous for ensuring a strict oversized particle demarcation in the range from 1 μm to 2 μm, which can preferably be represented on account of the physical properties of steam. Even with very low operating pressures of <2 bar(abs), the “overall” energy input with steam is also much higher, in particular roughly by a factor of 1.6, than with technical gases, such as air for example. Finally, the use of steam per se may be desirable for example on account of its inert properties or on account of surface-specific effects which lead, for example, to an improvement of the flowability.

The conventional production of superheated steam in a boiler plant is however often uneconomical at low pressure, since the usable enthalpy difference is disadvantageously small compared to the lost evaporation enthalpy.

### SUMMARY OF THE INVENTION

The present invention has and achieves the aim of creating an economical way of making available superheated steam in a jet mill plant and an operating method for the same.

This aim is achieved with jet mill plant and an operating method for a jet mill plant according to claims.

According to the invention, therefore, an operating method is created for a jet mill plant, wherein superheated steam at low pressure (2 to 10 bar) is used as an operating medium for a jet mill and the steam, after the jet mill and the separation of grinding stock, is circulated back again into the jet mill via a compressor for the excess pressure and temperature increase in the circuit.

Pressure data contained in the present documents are always indicated in the SI system and, for simplification, in “bar”, which is intended to mean “bar(abs)”.

Provision can also be advantageously made such that the relaxed steam at the suction side of the compressor has a pressure of approximately 1 bar and a temperature of approximately 105 to 115° C.

A further advantageous embodiment consists in the fact that the compressor has a one-stage design. A one-stage compressor has the particular advantage that the heat arising due to the compression is fully available for use. Multi-stage compressors require intermediate cooling, because otherwise the thermal load in the following stages is too high.

Provision can also preferably be made such that, as a result of water injection into the compressor, the temperature of the compressed steam after the compressor is controlled pressure-dependent so that superheated steam is present. In particular, the steam pressure on the exit side of the compressor lies between approximately 180° C. (2 bar) and approximately 250° C. (10 bar). The temperature increase in a compressor is pressure-dependent: the higher the pressure ratio, the more waste heat. The pressure should not be influenced by the water injection.

Furthermore, it is preferable if steam is supplied with a saturated steam generator on the suction side of the compressor in order to compensate for leakage steam loss in the circuit.

A further preferred embodiment consists in the fact that, in the case of a jet mill plant which comprises a jet mill with a classifier shaft and a bearing housing and with a classifier wheel and a fine-stock exit housing, the provision of seals between the classifier shaft and the bearing housing and between the classifying wheel and the fine-stock exit housing takes place with superheated steam.

Furthermore, the invention creates a jet mill plant with a jet mill which is designed to operate with superheated steam at low pressure (2 to 10 bar), wherein a jet mill steam discharge line, a compressor and a jet mill steam supply line together with the jet mill form a circuit for steam, so that steam from the jet mill is fed back again into the jet mill via the compressor for excess pressure and temperature increase in the circuit.

A preferred development thereof consists in the fact that the relaxed steam at the suction side of the compressor has a pressure of approximately 1 bar and a temperature of approximately 105 to 115° C.

Furthermore, provision can be made with preference and with the same advantages, as indicated above with respect to the embodiment according to the method, such that the compressor has a one-stage design.

Furthermore, it is preferable if the temperature of the compressed steam after the compressor is controlled pressure-dependent by the water injection into the compressor so that superheated steam is present. In particular, this can be provided in such a way that the steam temperature on the exit side of the compressor lies between approximately 180° C. (2 bar) and approximately 250° C. (10 bar).

Another preferred embodiment of the jet mill plant according to the invention consists in the fact that steam is supplied with a saturated steam generator on the suction side of the compressor in order to compensate for leakage steam loss in the circulatory system.

Provision can also preferably be made such that the jet mill plant comprises a jet mill with a classifier shaft and a bearing housing and with a classifying wheel and a fine-stock exit housing, and that the provision of seals between the classifier shaft and the bearing housing and between the classifying wheel and the fine-stock exit housing takes place with superheated steam.

According to the invention, steam is thus circulated in the circuit. In particular, the steam, after the jet mill, is duly purified with a filter and a downstream police filter supplied to the compressor for the pressure increase. The entry conditions into the compressor are preferably p≈1 bar and T≈105 to 115° C. The steam temperature increases depending on the pressure increase in the compressor. Theoretically, a ΔT of up to 200° C. can be reached in a one-stage compressor. At the desired low pressures of 2 to 10 bar, an exit temperature of 180 to 250° C. (depending on the pressure) is reached. The latter can also be adjusted by injecting water during the compression. The unavoidable leakage losses amounting in 5 to 8% of the circulating steam quantity in a circulatory steam system are thus advantageously compensated at least in part. If this is not sufficient, a small saturated steam generator, in particular, is able to feed in the lacking quantity on the suction side of the compressor.

Further preferred and/or advantageous embodiments of the invention and its individual aspects emerge from combinations of the dependent claims and from all the present application documents.

### BRIEF DESCRIPTION OF THE DRAWINGS

The invention is explained below in greater detail, merely by way of example, with the aid of examples of embodiment making reference to the drawing, in which

FIG. 1 shows, in a diagrammatic and partially cut-away representation, a first embodiment of a jet mill plant with a fluidized bed jet mill,

FIG. 2 shows, in a diagrammatic cross-sectional representation magnified with respect to FIG. 1, the fluidized bed jet mill of the first embodiment of the jet mill plant from FIG. 1,

FIG. 3 shows, in a diagrammatic and partially cut-away representation, a second embodiment of a jet mill plant with a fluidized bed jet mill, and

FIG. 4 shows, in a diagrammatic cross-sectional representation, an embodiment of a spiral jet mill or dense-bed jet mill from a jet mill plant according to the invention, as is shown in FIG. 1 or FIG. 3.

### DETAILED DESCRIPTION OF THE INVENTION

With the aid of examples of embodiments and applications described below and represented in the drawings, the invention is explained in greater detail merely by way of example, i.e. it is not limited to these examples of embodiments and applications. Features of the method and device similarly emerge in each case from the descriptions of the device and the method.

Individual features, which are stated and/or represented in connection with a specific embodiment, are not limited to that embodiment or the combination with the other features of that embodiment, but can, within the limits of technical feasibility, be combined with any other variants, even though they are not dealt with separately in the present document.

Identical reference numbers in the individual figures and illustrations of the drawing denote identical or similar or identically or similarly acting components. With the aid of the representations in the drawing, features which are not provided with reference numbers will also become clear, irrespective of whether such features are described below or not. On the other hand, features which are contained in the present description, but which are not visible or represented in the drawing, are also readily understandable to the person skilled in the art.

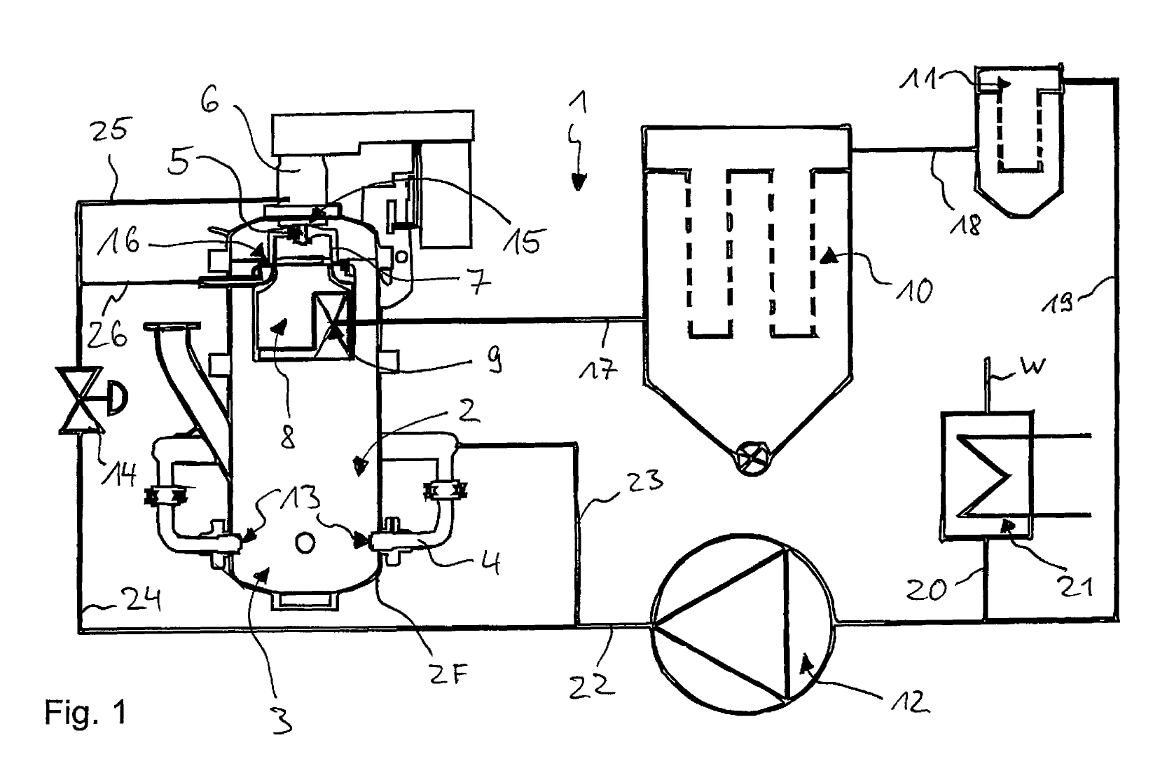

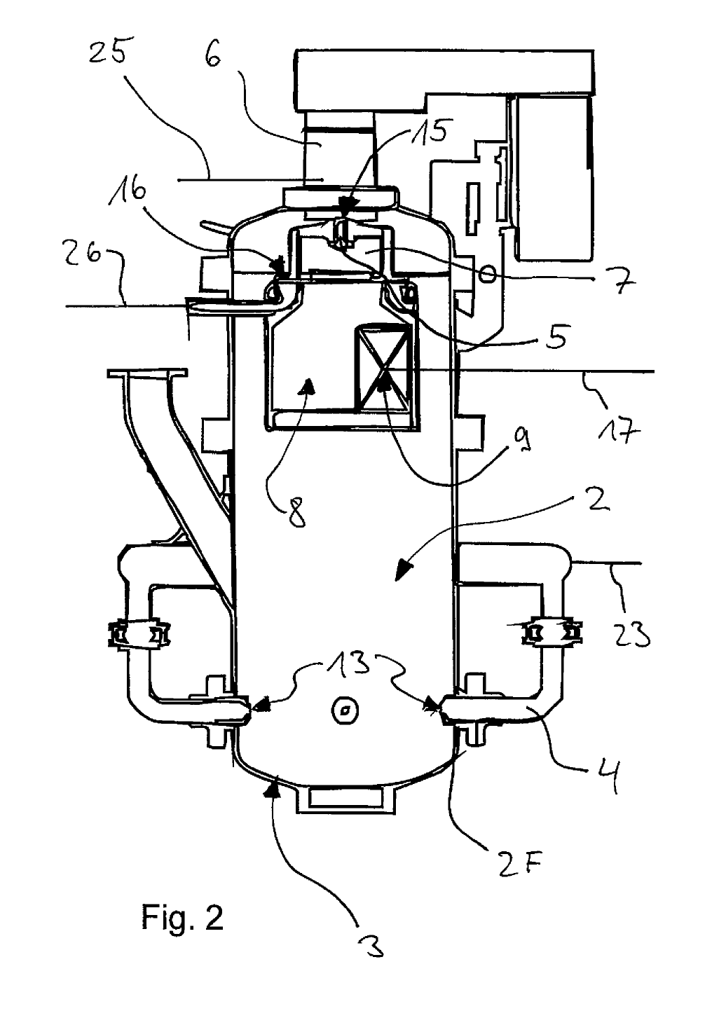

FIG. 1 shows, diagrammatically and partially cut away, a jet mill plant 1 operated with steam or superheated steam as a grinding gas or grinding steam. The jet mill plant comprises a jet mill 2, which is shown in FIG. 2 diagrammatically in a cross-sectional representation. The jet mill 2 is, merely by way of example in the present embodiment, a fluidized bed jet mill 2F. The present invention, however, is not limited to the use of a fluidized bed jet mill 2F in a jet mill plant according to the invention.

In the conventional manner, jet mill 2 comprises, amongst other things, a mill housing 3, a grinding steam inlet 4, a classifier shaft 5, a bearing housing 6 for classifier shaft 5, a classifying wheel 7 and a fine-stock exit housing 8 for a grinding stock outlet 9, to which a product filter 10 is assigned. The further embodiment of fluidized bed jet mill 2F provided in the present embodiment and, generally, of a jet mill 2 lies within the scope of standard technical practice and is not explained further here in detail, because any technically feasible designs and variants can moreover be combined here with the invention.

In product filter 10, the fine stock obtained by the grinding process is separated from the grinding gas, i.e. the steam, which is then circulated onward in particular for further purification in a police filter 11, from which it is circulated onward into a compressor 12. Compressor 12 is a one-stage compressor. A one-stage compressor has the particular advantage that the heat arising due to the compression is fully available for use. If a multi-stage compressor is used, intermediate cooling has to be provided, because otherwise the thermal load in subsequent stages is too high.

The grinding steam with a correspondingly raised temperature is circulated from the outlet of compressor 12 to jet mill 2, where it is introduced via nozzles 13 into the grinding process.

The superheated steam obtained from compressor 12 is provided, preferably via pressure reducing devices 14, as scavenging steam for a scavenging gap 15 of classifier shaft 5 and a scavenging gap 16 of classifying wheel 7 (see FIG. 2). A seal is thus produced with correspondingly superheated steam between classifier shaft 5 and bearing housing 6 and between classifying wheel 7 and fine-stock exit housing 8.

In the grinding process, therefore, steam is thus made available and used as a grinding gas via nozzles 13 in jet mill 2. In the course of the grinding process, which like jet mill 2 can be designed in any conventional way, the steam cools down and finally enters, together with ground fine stock, into fine-stock exit housing 8 and exits jet mill 2 through grinding stock outlet 9. A product filter 10 is assigned to the grinding stock outlet 9 internally or externally with respect to mill housing 3, in which the obtained grinding stock is separated from the grinding gas, i.e. the cooled steam. If product filter 10 is disposed outside mill housing 3, an outlet line 17 is provided between grinding stock outlet 9 and product filter 10, from which the grinding stock can be removed or carried away in any conventional manner.

The grinding gas separated from the grinding product in product filter 10, i.e. the steam used for the grinding process, passes via a used steam discharge line 18 for further purification, if required, into police filter 11, from which the steam to be processed, i.e. to undergo a temperature increase, is fed through a compressor supply line 19 to compressor 12. A generator supply line 20 is connected to the compressor supply line 19 before compressor 12, through the generator supply line the steam can be fed from a saturated steam generator 21, which is supplied from a fresh water supply line W, into compressor supply line 19. The expression “fresh water” merely signifies here that water that is fresh with respect to the system of jet mill plant 1, i.e. additional water coming from outside and not yet used in the process, is used and it does not say anything about the quality of the water in the other respects.

The steam from saturated steam generator 21 performs two functions. On the one hand, the steam required to put jet mill plant 1 into operation is made available by saturated steam generator 21. On the other hand, steam that has disappeared during the operation of jet mill plant 1 due to leakage losses can at least partially be compensated for, in that the lacking quantity of steam or at least a part thereof can be fed in by means of the, in particular, small saturated steam generator 21 on the suction side of compressor 12, i.e. into compressor supply line 19.

The steam heated by the pressure increase in compressor 12 passes from compressor 12 through a compressor discharge line 22 into a nozzle supply line 23 and from there via grinding steam inlet 4 of mill housing 3 to nozzles 13 in the jet mill, where the superheated steam is used as a grinding gas in the grinding process. The steam is thus circulated in a circuit in jet mill plant 1 and, after jet mill 2, is fed, duly purified in product filter 10 and downstream police filter 11, to compressor 12 for the pressure increase.

In the present example of embodiment, the entry conditions into compressor 12 are p≈1 bar and T≈105 to 115° C. The steam temperature increases depend on the pressure increase in compressor 12. Theoretically, a ΔT of up to 200° C. can be reached in a one-stage compressor 12. At the desired low pressures of 2 to 10 bar, an exit temperature of the steam from the compressor of 180 to 250° C. is reached (depending on the pressure).

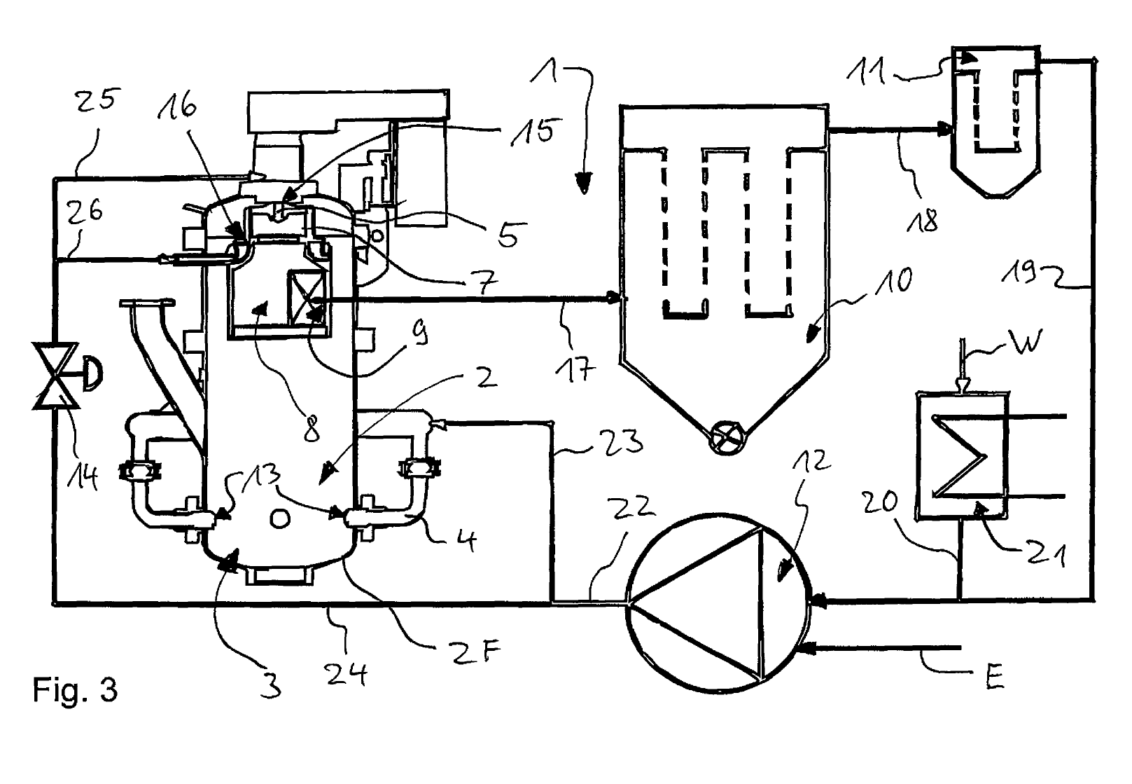

In another embodiment of jet mill plant 1 shown in FIG. 3, the exit temperature is additionally adjusted by the fact that, during the compression in compressor 12, water is injected from a water injection supply line E. Thus, i.e. with the corresponding water injection, the unavoidable leakage losses amounting to 5 to 8% of the circulating steam quantity in a circulatory steam plant are at the same time compensated for at least in part. If this is not sufficient, the lacking quantity can be fed in on the suction side of compressor 12, for example by means of the (small) saturated steam generator 21. With the exception of water injection supply line E and the water injection into the compressor thus produced, the second embodiment of jet mill plant 1 according to FIG. 3 is in agreement with the first embodiment of jet mill plant 1 according to FIG. 1 and will not therefore be described in detail again, but rather reference will be made in respect to all other features to the representations in respect to FIGS. 1 and 2 concerning the first example of embodiment of jet mill plant 1.

In the first and in the second embodiments of jet mill plant 1, the steam emerging from compressor 12 with the required temperature is circulated via compressor discharge line 22 and nozzle supply line 23 to grinding steam inlet 4 and then onward to nozzles 13 and thus passes into the grinding process, and the circuit is thus closed.

For the aforementioned sealing purposes, on the one hand of scavenging gap 15 of classifier shaft 5 between classifier shaft 5 and bearing housing 6 and on the other hand of scavenging gap 16 of classifying wheel 7 between classifying wheel 7 and fine-stock exit housing 8, there branches off from compressor discharge line 22, apart from nozzle supply line 23, also a main scavenging line 24, which contains pressure reducing devices 14 for reducing the pressure of the steam from compressor 12 used as scavenging steam and which, following this, splits up into a shaft scavenging-gap supply line 25 for scavenging gap 15 of classifier shaft 5 and a wheel scavenging-gap supply line 26 for scavenging gap 16 of classifying wheel 7, as can be seen in FIGS. 1 and 2.

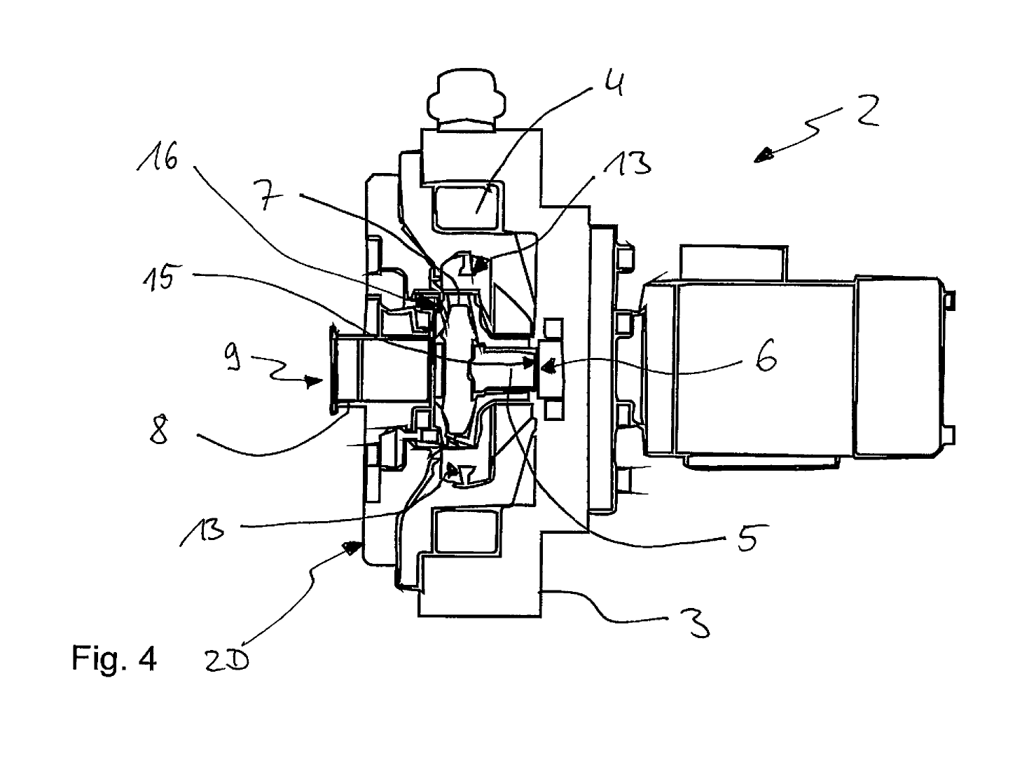

A spiral jet mill or dense-bed jet mill 2D is shown diagrammatically in cross-section in FIG. 4, such as can be used as jet mill 2 in a jet mill plant 1 according to the invention, e.g. instead of fluidized bed jet mill 2F according to FIGS. 1 and 2 as well as 3. Similar to those of fluidized bed jet mill 2F according to FIGS. 1 and 2 as well as 3, the corresponding inlets and outlets of spiral jet mill or dense-bed jet mill 2D can be connected to outlet line 17 of grinding mill outlet 9 and product filter 10, to nozzle supply line 23 to nozzles 13, to shaft scavenging-gap supply line 25 for scavenging gap 15 of classifier shaft 5 between classifier shaft 5 and bearing housing 6 and to scavenging-gap supply line 26 for scavenging gap 16 of classifying wheel 7 between classifying wheel 7 and fine-stock exit housing 8, in order to integrate spiral jet mill or dense-bed jet mill 2D into jet mill plant 1 according to FIGS. 1 and 3.

Like fluidized bed jet mill 2F according to FIGS. 1 and 2 as well as 3, spiral jet mill or dense-bed jet mill 2D as jet mill 2 in jet mill plant 1 also comprises, amongst other things, grinding housing 3, grinding steam inlet 4, classifier shaft 5, bearing housing 6 for classifier shaft 5, classifying wheel 7 and fine-stock exit housing 8 for grinding stock outlet 9, to which product filter 10 is assigned.

The further embodiment of spiral jet mill or dense-bed jet mill 2D as jet mill 2 provided in the present example of embodiment lies within the scope of standard technical practice and is not explained further here in detail, because any technically feasible designs and variants can moreover be combined with the invention.

The invention is represented merely by way of example with the aid of the embodiments in the description and in the drawings and is not limited thereto, but comprises all variations, modifications, substitutions and combinations which the person skilled in the art can derive from the present document, in particular within the scope of the claims and the general statements in the introduction of this description as well as the description of the examples of embodiment and which the skilled worker can combine with his specialist knowledge as well as the prior art. In particular, all the individual features and possible embodiments of the invention can be combined.

### LIST OF REFERENCE NUMBERS

1 jet mill plant
2 jet mill
2F fluidised bed jet mill
2D spiral jet mill or dense-bed jet mill
3 mill housing
4 grinding steam inlet
5 classifier shaft
6 bearing housing
7 classifying wheel
8 fine-stock exit housing
9 grinding stock outlet
10 product filter
11 police filter
12 compressor
13 nozzles
14 pressure reducing devices
15 scavenging gap of classifier shaft 5
16 scavenging gap of classifying wheel 7
17 outlet line
18 used steam discharge line
19 compressor supply line
20 generator supply line
21 saturated steam generator
22 compressor discharge line
23 nozzle supply line
24 main scavenging line
25 shaft scavenging-gap supply line
26 wheel scavenging-gap supply line
E water injection supply line
W fresh water supply line

1. An operating method for a jet mill plant characterized in that superheated steam at low pressure (2 to 10 bar) is used as an operating medium for a jet mill, and the steam, after the jet mill and separation of grinding stock, is circulated back again into the jet mill via a compressor for excess pressure and temperature increase in a circuit for the steam.

2. The operating method for a jet mill plant according to claim 1, characterized in that the relaxed steam on a suction side of the compressor has a pressure of approximately 1 bar and a temperature of approximately 105 to 115° C.

3. The operating method for a jet mill plant according to claim 1, characterized in that the compressor has a one-stage design.

4. The operating method for a jet mill plant according to claim 1, characterized in that a temperature of the compressed steam after the compressor is controlled pressure-dependent by water injection into the compressor in such a way that superheated steam is provided.

5. The operating method for a jet mill plant according to claim 4, characterized in that the temperature on an exit side of the compressor is between approximately 180° C. (2 bar) and approximately 250° C. (10 bar).

6. The operating method for a jet mill plant according to claim 1, characterized in that steam is supplied with a saturated steam generator on a suction side of the compressor in order to compensate for leakage steam loss in the circuit.

7. The operating method for a jet mill plant according to claim 1, wherein the jet mill comprises a classifier shaft with a bearing housing and a classifying wheel with a fine-stock exit housing, and
a provision of seals between the classifier shaft and the bearing housing and between the classifying wheel and the fine-stock exit housing takes place with superheated steam.

8. A jet mill plant comprising:
a jet mill designed to operate with superheated steam at low pressure (2 to 10 bar),
characterized in that a jet mill steam discharge line, a compressor and a jet mill steam supply line form together with the jet mill a circuit for steam, so that steam is circulated from the jet mill back again into the jet mill via the compressor for excess pressure and temperature increase in the circuit.

9. The jet mill plant according to claim 8, characterized in that the relaxed steam at a suction side of the compressor has a pressure of approximately 1 bar and a temperature of approximately 105 to 115° C.

10. The jet mill plant according to claim 8, characterized in that the compressor has a one-stage design.

11. The jet mill plant according to claim 8, characterized in that a temperature of the compressed steam after the compressor is controlled pressure-dependent by water injection into the compressor in such a way that superheated steam is provided.

12. The jet mill plant according to claim 11, characterized in that steam temperature on an exit side of the compressor is between approximately 180° C. (2 bar) and approximately 250° C. (10 bar).

13. The jet mill plant according to claim 8, characterized in that steam is supplied with a saturated steam generator on a suction side of the compressor in order to compensate for leakage steam loss in the circuit.

14. The jet mill plant according to claim 8, characterized in that the jet mill comprises a classifier shaft with a bearing housing and a classifying wheel with a fine-stock exit housing, and that a provision of seals between the classifier shaft and the bearing housing and between the classifying wheel and the fine-stock exit housing takes place with superheated steam.
